(19) United States
(12) Patent Application Publication
(10) Pub. No.: US 2011/0143232 A1
(43) Pub. Date: Jun. 16, 2011

(54) Gel-Filled Membrane Device and Method

(76) Inventors: John H. Burban, Lake Elmo, MN (US); John W. Shanahan, White Bear Lake, MN (US); Robert O. Crowder, Lino Lakes, MN (US); Xijing Zhang, St. Paul, MN (US)

(21) Appl. No.: 12/943,813

(22) Filed: Nov. 10, 2010

Related U.S. Application Data
(60) Provisional application No. 61/259,892, filed on Nov. 10, 2009.
(60) Provisional application No. 61/260,331, filed on Nov. 11, 2009.

(51) Int. Cl. H01M 8/06; B01D 53/22; B01D 71/06

(52) U.S. Cl. 429/414; 96/4; 96/10; 261/101

(57) ABSTRACT

Embodiments of the invention provide a membrane between a first stream of fluid that is partially or wholly in a gas phase and a second stream of fluid. The membrane includes a porous support and pores filled with a gel. The gel can selectively facilitate a transfer of compounds from the first stream to the second stream. The gel can be partially composed of the transferred compounds or materials with similar properties to the transferred compounds.

### RELATED APPLICATIONS

This application claims priority under 35 U.S.C. §119 to U.S. Provisional Patent Application Nos. 61/259,892 filed on Nov. 10, 2009 and 61/260,331 filed on Nov. 11, 2009, the entire contents of which are incorporated herein by reference.

### BACKGROUND

Selective transfer of gas and/or liquid from one fluid stream to another has many applications in a wide range of market sectors. Membranes are an attractive technology for this purpose, as they can provide the selectivity required along with large surface areas for mass transfer. Further, membrane devices are passive relative to conventional technologies, a feature that makes them operationally robust by comparison.

Some important characteristics associated with a successful membrane device include sufficient mechanical strength, resistance to contamination, and low pressure drop across the membrane module. In addition, membranes that provide high selectivity coupled with rapid transport rates can improve the quality of separation that may be achieved.

### SUMMARY

Some embodiments of the invention provide a membrane between a first stream of fluid that is partially or wholly in a gas phase and a second stream of fluid. The membrane includes a porous support and pores that are partially or completely filled with a gel. The gel can selectively facilitate a transfer of compounds from the first stream to the second stream and/or the second stream to the first stream. The gel can be partially composed of the transferred compounds or materials with similar properties to the transferred compounds. The gel can comprise, at least in part, a dilute network of cross-linked polymers and a liquid.

Some embodiments of the invention provide a module for humidifying a gas, such as an explosive gas, using a humidifying stream. The module includes a first flow path for the gas, a second flow path for the humidifying stream, and a membrane separating the first flow path and the second flow path. The membrane includes a porous support filled with a hydrophilic gel. The hydrophilic gel facilitates the transfer of water from the humidifying stream across the membrane to the gas and minimizes the unwanted transfer of gas across the membrane.

Some embodiments of the invention provide a humidifier for a fuel cell. The humidifier includes a first flow path for a reactant, a second flow path for a humidifying stream, and a membrane with gel-filled pores separating the first flow path and the second flow path. The gel-filled pores allow the transfer of water from the second flow path to the first flow path to humidify the reactant. The humidifier also includes a first flow path outlet leading humidified reactant from the first flow path to the fuel cell. The humidifier further includes a second flow path inlet leading humidified exhaust from the fuel cell to the second flow path to replenish the humidifying stream.

### DESCRIPTION OF THE DRAWINGS

FIG. 1 is a schematic view of a membrane according to one embodiment of the invention.

FIG. 2 is a cross-sectional view of a membrane according to one embodiment of the invention.

FIG. 3 is a side view of a membrane module according to one embodiment of the invention.

FIG. 4 is another cross-sectional view of the membrane of FIG. 2.

FIG. 5 is a schematic view of a membrane according to one embodiment of the invention used in a fuel cell application.

FIG. 6 is a schematic view of a membrane according to one embodiment of the invention used in another fuel cell application.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

The following discussion is presented to enable a person skilled in the art to make and use embodiments of the invention. Various modifications to the illustrated embodiments will be readily apparent to those skilled in the art, and the generic principles herein can be applied to other embodiments and applications without departing from embodiments of the invention. Thus, embodiments of the invention are not intended to be limited to embodiments shown, but are to be accorded the widest scope consistent with the principles and features disclosed herein. The following detailed description is to be read with reference to the figures, in which like elements in different figures have like reference numerals. The figures, which are not necessarily to scale, depict selected embodiments and are not intended to limit the scope of embodiments of the invention. Skilled artisans will recognize the examples provided herein have many useful alternatives and fall within the scope of embodiments of the invention.

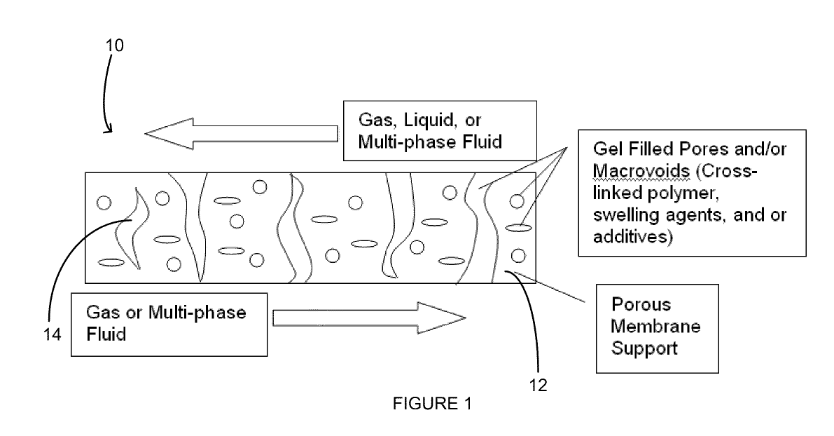

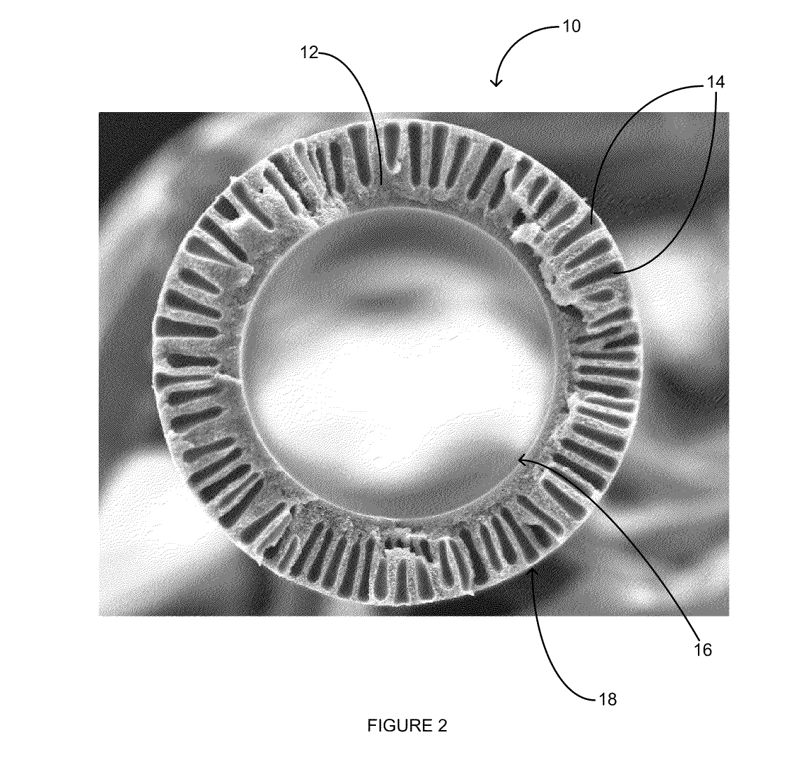

FIG. 1 illustrates a membrane 10 according to one embodiment of the invention. The membrane 10 can include a porous membrane support 12 and macrovoids, or larger pores, 14. In some embodiments, as shown in FIG. 2, the membrane 10 can have a circular cross-sectional structure including the porous membrane support 12 and/or the macrovoids 14. The membrane 10 can have a lumen (internal) side 16 and a shell (external) side 18. As shown in FIG. 1, the membrane 10 can be contacted by two separate streams. For example, a first stream can flow along the lumen side 16 and a second stream can flow along the shell side 18. In some embodiments, the membrane 10 can be incorporated into a device (not shown) to enclose the first stream and the second stream.

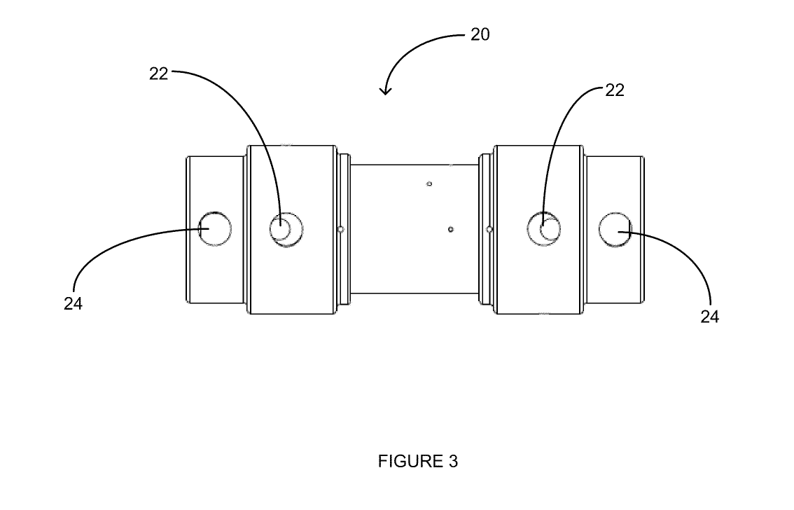

FIG. 3 illustrates one example of a membrane module 20 that can house the membrane 10. The membrane module 20 can include shell side ports 22 and lumen side ports 24. In one embodiment, the first stream can enter and exit the lumen side ports 24 and the second stream can enter and exit the shell side ports 22. Within the membrane module 20, the first stream and the second stream can be separated by the membrane 10. The first stream and the second stream can each include gas, liquid, or multi-phase streams, where at least one of the two streams possesses a gas phase. The two streams can operate in co-current flow, counter-current flow, cross-flow, radial flow, or some combination of these flows. For example, FIG. 1 illustrates the two fluids streams operating in counter-current flow.

in some embodiments, phase transfer can occur within one or both of the streams. Molecules in the streams can be transported across the membrane 10, in order to enrich or deplete a given stream of one or more components. For example, one or both of the two streams can have a gas phase and/or liquid phase component which can be transferred across the membrane. Heat transfer across the membrane 10 can also occur. The extent of heat transfer can be dependent upon the membrane 10, the construction of the membrane module 20, and the conditions under which the membrane module 20 is operated.

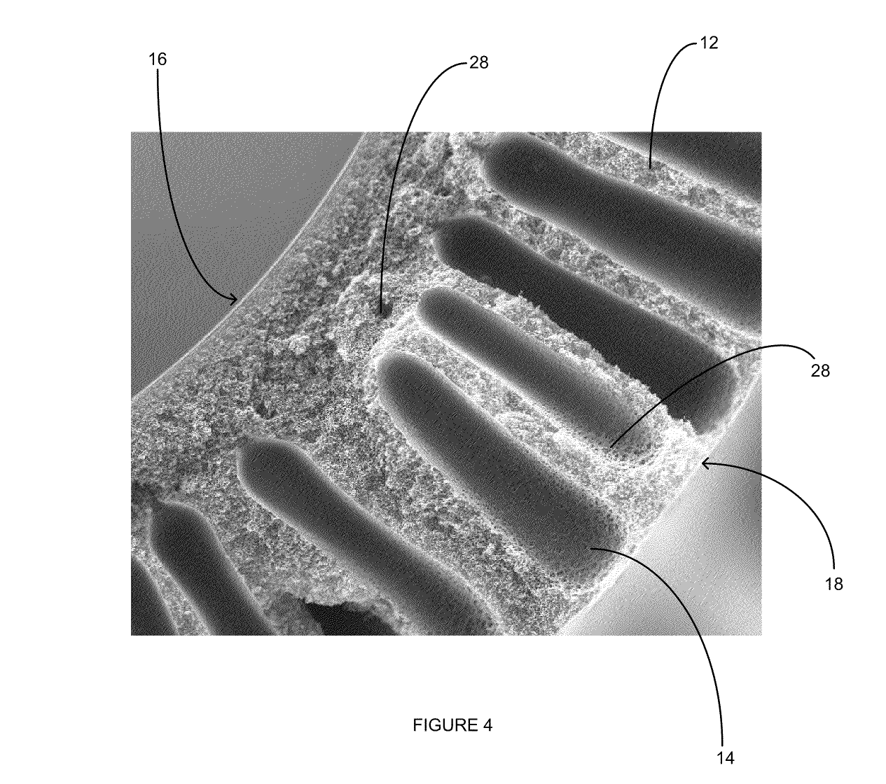

The porous membrane support 12 and/or the macrovoids 14 can be fully or at least partially filled with a gel to facilitate selective transfer of gas or liquid into or out of the fluid streams. The gel can remain within the interior of the membrane 10 despite differential pressures across the membrane 10. In some embodiments, the porous membrane support 12 can have pore sizes that are characteristic of microfiltration and/or ultrafiltration membranes. Further, the porous membrane support 12 and/or the macrovoids 14 can have either symmetric or asymmetric pore patterns. The distribution of pore sizes within the membrane 10 can also be varied to suit a particular application. FIG. 4 illustrates the porous membrane support 12 and the macrovoids 14 according to one embodiment of the invention. As shown in FIG. 4, both the porous membrane support 12 and the macrovoids 14 can include substantially small, grainy pores 28. The gel can fill both the larger macrovoids 14 as well as the smaller grainy pores 28.

Transport properties through the membrane 10 can be governed in part by the nature of the gel located within the porous membrane support 12 and/or the macrovoids 14. In some embodiments, the gel can include polymeric chains that have varying degrees of cross-linking. The extent of the cross-linking can be varied to optimize the membrane 10 for a given application. For example, the nature of the first stream and the second stream can vary in different applications. As a result, different gel compositions can be used for different applications for optimal mass transfer of desired components. Also, the gel can have varying concentrations of additional molecules and/or polymers added to it. These additional components can be intentionally added to the gel to confer specific properties, chemistries, and/or reactivities to the gel. In another example, the gel can be comprised at least in part of a dilute network of cross-linked polymers and a liquid. Polymers that make up a portion of the gel can be functionalized to influence transport properties through the gel. In some embodiments, the gel can have zones of greater and lesser cross-linking. In addition, the gel can provide additional strength to the membrane 10.

In one embodiment, the gel can be hydrophilic. The hydrophilic gel can include cross-linked hydrophilic polymers, such as but not limited to, polyethylene oxide, polythylene glycol, polyvinyl alcohol, polyvinylpyrrolidone, and/or polyacrylate. Additives to the gel can include hydrophillic polymers, such as but not limited to, polyvinylalcohol, polyacrylate, polyethyleneglycol, and/or polydextrose. Other additives can include humectants such as sorbitol, glycerol, and/or urea. In some applications, the gel can lose water over the entire membrane 10 or in localized areas of the membrane 10. As a result, transport properties across the gel can be altered and cracks and/or leak paths can also develop across the gel-filled membrane 10 as a result of gel dehydration. The addition of humectants can plasticize the gel and reduce shrinking in such applications, thus reducing the negative impacts gel drying can have the membrane module performance. In addition, in some embodiments, the gel can include swelling agents. In the absence of humectants or swelling agents, the permeability of gasses through the membrane may remain very small relative to a membrane with a similar pore structure that does not contain a gel.

The porous membrane support 12 can be polymeric and can provide substantial strength and resistance to cycle fatigue for the membrane 10. In some embodiments, the porous membrane support 12 can include a thermoplastic polymer, such as but not limited to, polysulfone, polyethersulfone, polyvinylidene fluoride, polyamide, polyimide, polyetherimide, polypropopylene, polyethylene, polyetheretherketone, and/or polyvinylchloride. In addition, additives can be included in the polymeric porous membrane support 12, such as surfactants, humectants, salts, acids, bases, and other polymers. In other embodiments, the membrane support can include ceramics or metals. The porous membrane support 12 can be responsible in part for the strength, thermal tolerance, and chemical resistance of the membrane 10. As such, the chemistry and morphology of the porous membrane support 12 can be varied to suit a given application.

The membrane module 20 can be designed to optimize mass transfer across the membrane 10, heat transfer across membrane 10, and energy losses in the fluid streams supplied to the membrane module 20. In some embodiments, the membrane module 20 can include one or more flat sheet, hollow fiber, or tubular membranes 10. The membrane or membranes 10 can be placed within the membrane module 20 to encourage counter-current flow, co-current flow, cross-flow, radial flow, or some combination of the above. In some embodiments, media (not shown) can be placed between the shell side ports 22 and the membrane 10 to protect the membrane 10 from particulates, chemicals, and/or inertia of the incoming or outgoing streams. The media can intercept particles, sorb chemicals, and/or reduce the local velocity of the incoming fluid stream. Interception of particles can reduce mechanical failures associated with impaction on and/or abrasion of the membrane surfaces. Sorption of chemicals can reduce the potential for chemical attack of the membranes 10. Reduced fluid velocity on the shell side 18 can reduce the vibration of the membranes 10 and/or shear forces on the membranes 10, thus reducing the possibility of mechanical failure of the membranes 10. The media can also be included to increase the functionality of the membrane module 20. The media can be foam, felt, activated carbon, zeolites, ion exchange resins, silica beads, and/or other suitable materials. The surrounding environment and/or the temperature of the membrane module 20 can also be controlled to optimize the performance of mass and/or heat transfer across the membrane 10.

The placement of membranes 10 and/or media can be tailored to encourage mixing within the fluid streams. In one embodiment, hollow fiber membranes 10 can be helically wound around a central core (not shown). In another embodiment, hollow fibers can be aligned axially parallel with the flow of streams in the membrane module 20, or the hollow fibers can be arranged so that the stream outside of the hollow fibers flows at an angle relative to the axis of the fibers. In yet another embodiment, flat sheet membranes 10 can be arranged in a spiral wound element, as a pleated media, or in a plate and frame arrangement.

In one embodiment, the membrane 10 can be used in an application for the humidification of explosive gases. In this application, the first stream can be a humidifying stream including a humid gas stream, a multi-phase stream that contains humid gas stream and water, or a liquid stream that contains water, which is passed along one side of the membrane 10 (e.g., the lumen side 16). The second stream can consist of an explosive gas to be humidified, such as hydrogen, which is passed along the other side of the membrane 10 (e.g., the shell side 18). The membrane 10 can have a porous support 12 and macrovoids 14 filled with a hydrogel and additives. Water can be transported from the humidifying stream to the explosive gas via the membrane module 20 through the gel-filled membrane 10. Simultaneously, the membrane 10 can minimize the transport of explosive gases into the humidifying stream. One or more humectants can be added to the gel to reduce the extent of gel desiccation and/or the effects gel desiccation can have on the performance of the membrane module 20.

Rather than using the hydrogel to fractionate a mixture of biomolecules (such as in some biotechnology applications), the membrane 10 according to embodiments of the invention can use the hydrogel to selectively transfer certain molecules at a faster rate than others between the two separate streams, where one of the two streams is partially or wholly comprised of a gas phase. The hydrogel and/or additives can allow the membrane 10 to provide higher selectivity for water over other gases compared to conventional polymeric membranes. Further, the hydrogel and/or additives can increase the rate of water transport across the membrane 10 compared to conventional membranes. The porous support 12 can withstand burst and/or collapse strengths that are in excess of operating pressures. For example, in some embodiments, the porous support 12 can withstand burst strengths up to about 1000 pounds per square inch (PSI). In addition, the porous membrane support 12 and the macrovoids 14 can have a sufficient pore size and distribution to ensure that the gel is not extruded from the membrane 10 under the operating conditions employed. The gel can also be constructed to ensure that it remains within the membrane 10. For example, the gel can include cross-linked hydrophilic or hydrophobic polymers sufficiently entangled in the pore structure of the porous membrane support 12 and the macrovoids 14 to prevent migration out of the membrane 10 at operating pressures. In addition, the gel can be covalently bonded to a polymer that makes up the porous membrane support 12.

The presence of the gel within the porous membrane support 12 and/or the macrovoids 14 can allow the membrane 10 to retain liquid droplets or gaseous components that are intercepted on the membrane surface. In some embodiments, these droplets and components in, for example, the first stream can have chemistries or properties that are similar to the gel. In addition, the droplets and components can be the same compounds that make up a portion of the gel. Intercepted droplets and components can be transferred across the membrane 10 into the second fluid stream. The gel can present minimal resistance to transfer of the droplets or components, especially when the droplets or components make up a significant portion of the gel. The gel can present a significant resistance to other compounds in the gas and or liquid that are dissimilar to the chemistry of the gel and/or do not make up a significant portion of the gel. As a result, the gel-filled membrane 10 can provide good selectivity of certain compounds over others. In one example, the gel can be composed of up to about 90 percent water, which can facilitate a high transfer rate of water across the membrane 10 while resisting the transfer of other compounds.

In addition, when the desired transfer element is common to both the droplets and the gas phase component, the interception and transfer of the liquid droplets on the membrane surface can diminish the influence of a gas concentration boundary layer near the membrane surface (i.e., on the side of the membrane 10 exposed to the droplets). By reducing elects of the boundary layer, the membrane 10 can provide a higher rate of mass transfer.

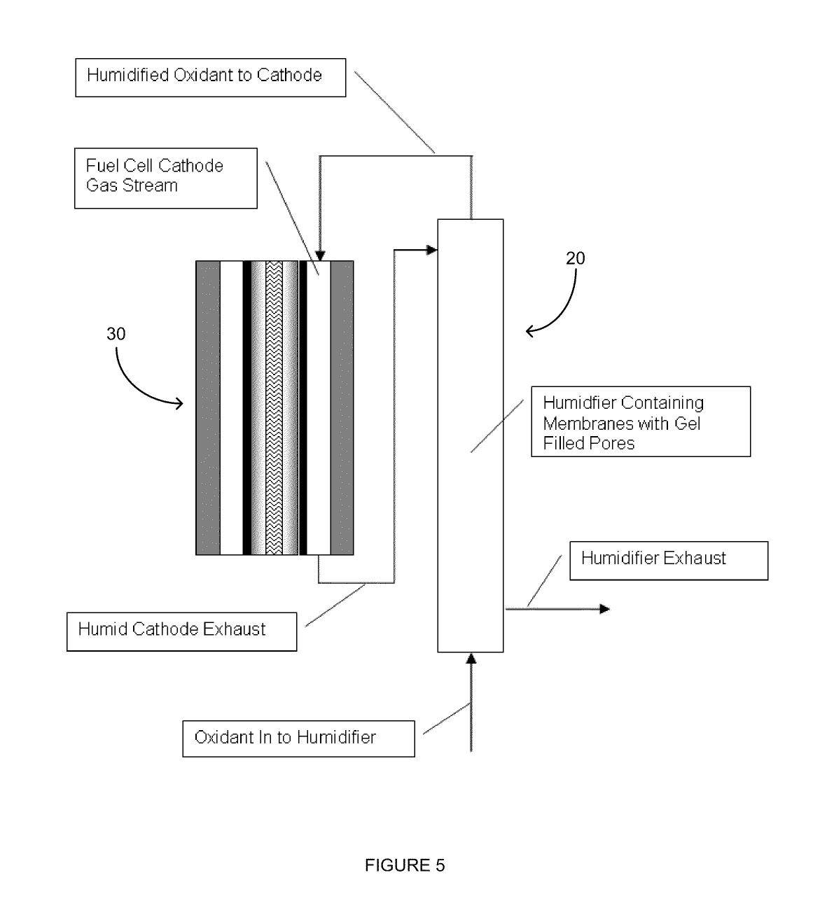

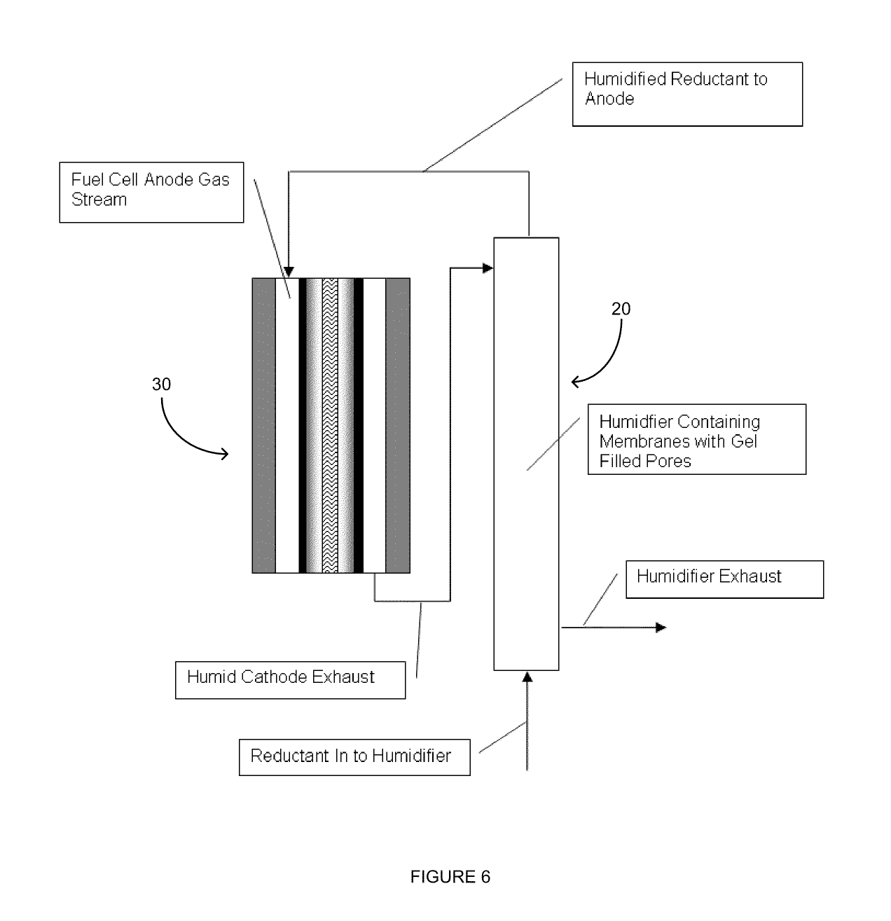

In some embodiments, as shown in FIGS. 5 and 6, the membrane can be used in fuel cell applications. The membrane module 20 shown in FIGS. 5 and 6 can include one or more membranes 10 with a porous support 12 and/or macrovoids 14 filled with hydrophilic gel. The membranes 10 can be used to humidify a gas stream. The gas stream to be humidified can be supplied to the membrane module 20 and can contact one side of the membrane 10. The other “wet” side of the membrane 10 can be contacted with a humid gas, a mixture of humid gas and liquid droplets, or liquid water. Water can be transported across the gel filled membrane 10 from the wet side to the dry gas that is to be humidified. In the case where the wet side of the membrane is contacted with humid gas and liquid droplets, the gel can facilitate the membrane's ability to retain and transfer these droplets. As a result, the gel can increase the rate of transfer of water across the membrane 10. In the case where the wet side is predominantly liquid water, the gel can provide minimal resistance to the transport of liquid water across the membrane 10. Gases in either of the two streams that do not make up a significant portion of the gel and/or have low solubility in the gel can experience a high resistance to mass transfer across the membrane 10. As such, the transfer of these gases can be very minimal relative to the rate of water transport across the membrane 10. In all of these cases, the gel can minimize or substantially prevent forced convection of gases or liquids across the membrane 10.

In the fuel cell applications, the hydrogel-filled membranes 10 are part of a membrane module 20 that is separate from the fuel cell stacks and acts as a humidifier to externally recover water from a fuel cell exhaust stream. Rather than placing a hydrogel within the fuel cell stack itself, as seen in some applications, the hydrogel is located within the porous membrane support 12 and/or the macrovoids 14 of the membrane 10.

In the application shown in FIG. 5, the gas to be humidified can be an oxidant stream for a cathode of a fuel cell 30. The oxidant is supplied to the membrane module 20, humidified, and exits the membrane module 20 to a cathode inlet. The cathode exhaust, which is still humidified, can be routed to the membrane module 20 as the humidifying stream for the incoming oxidant.

In the application shown in FIG. 6, the gas to be humidified can be a reductant stream for an anode of the fuel cell 30. The reductant is supplied to the membrane module 20, humidified, and exits the membrane module 20 to an anode inlet. The cathode exhaust can be routed to the membrane module 20 as the humidifying stream for the incoming reductant.

In another embodiment, the membrane 10 can be used in an application to remove organic aerosols and/or vapors from a first gas stream. The first gas stream treated can be supplied to the membrane module 20 and flow along one side of the membrane 10 (e.g., the lumen side 16). The other side of the membrane 10 (e.g., the shell side 18) can be in contact with a second gas stream or a liquid stream. The gel in the membrane 10 can be similar in chemistry to one or more organic compounds in the first stream. The similar organic compounds can be those which are to be removed from the first stream. The organic compounds can be transported across the membrane 10, thus reducing their concentration in the first gas stream. If the treated side of the membrane is contacted with organic vapors and liquid droplets, the gel can facilitate the membrane's ability to retain and transfer these droplets. This in turn, can increase the rate of transfer of the organics across the membrane 10. If a liquid receives the captured vapors and/or droplets, the gel can provide minimal resistance to the transport of the organics across the membrane 10. Gases in either of the two streams that do not make a significant portion of the gel and/or have low solubility in the gel can experience a high resistance to mass transfer across the membrane 10. As such, the transfer of these gases may be very minimal relative to the rate of organic transport across the membrane 10. In all of these cases, the gel can minimize or substantially prevent forced convection of gases or liquids across the membrane.

It will be appreciated by those skilled in the art that while the invention has been described above in connection with particular embodiments and examples, the invention is not necessarily so limited, and that numerous other embodiments, examples, uses, modifications and departures from the embodiments, examples and uses are intended to be encompassed by the claims attached hereto. The entire disclosure of each patent and publication cited herein is incorporated by reference, as if each such patent or publication were individually incorporated by reference herein. Various features and advantages of the invention are set forth in the following claims.

1. A membrane device comprising:
a first fluid stream including at least one gas phase component;
a second fluid stream; and
a membrane separating the first fluid stream and the second fluid stream, the membrane including a porous support and pores one of partially and completely filled with a gel, the gel being at least partially composed of one of the at least one gas phase component and a material with similar properties to the gas phase component.

2. The membrane device of claim 1, wherein the gel facilitates transfer of the gas phase component from the first fluid stream to the second fluid stream by intercepting the gas phase component on a surface of the membrane adjacent to the first fluid stream and transferring the gas phase component to the second fluid stream.

3. The membrane device of claim 1, wherein the second fluid stream includes a liquid, and the gel at least partially inhibits transfer of the liquid from the second fluid stream to the first fluid stream.

4. The membrane device of claim 1, wherein the porous support includes a thermoplastic polymer.

5. The membrane device of claim 1, wherein the membrane is one of a flat sheet membrane, a hollow fiber membrane, and a tubular membrane.

6. The membrane device of claim 1, wherein the gel includes cross-linked hydrophilic polymers.

7. The membrane device of claim 6, wherein the cross-linked hydrophilic polymers are substantially entangled in the porous support to prevent migration of the gel out of the pores.

8. The membrane device of claim 6, wherein the gel includes one of humectants and swelling agents.

9. The membrane device of claim 6, wherein the porous support includes at least one of surfactants, humectants, salt additives, acid additives, base additives, and polymer additives.

10. The membrane device of claim 1, wherein the gel includes cross-linked hydrophobic polymers.

11. The membrane device of claim 10, wherein the cross-linked hydrophobic polymers are substantially entangled in the porous support to prevent migration of the gel out of the pores.

12. The membrane device of claim 10, wherein the gel includes swelling agents.

13. The membrane device of claim 10, wherein the porous support includes at least one of surfactants humectants, salt additives, acid additives, base additives, and polymer additives.

14. A module for humidifying a gas using a humidifying stream, the module comprising:
a first flow path for the gas;
a second flow path for the humidifying stream; and
a membrane separating the first flow path and the second flow path, the membrane including a porous support filled with a hydrophilic gel.

15. The module of claim 14, wherein the hydrophilic gel facilitates transfer of water from the humidifying stream across the membrane to the gas and minimizes transfer of the gas across the membrane to the humidifying stream.

16. The module of claim 14, wherein the hydrophilic gel includes up to about 90 percent water.

17. The module of claim 14, wherein the permeability of gasses through the membrane including the hydrophilic gel is significantly less than through a similar membrane without gel-filled pores.

18. The module of claim 14, and further comprising first flow path ports and second flow path ports.

19. The module of claim 18, and further comprising media between the second flow path ports and the membrane to substantially protect the membrane from at least one of particulates, chemicals, and high velocity flow of the humidifying stream.

20. The module of claim 14, wherein the gas is an explosive gas and the humidifying stream includes one of humid gas, a mixture of humid gas and liquid droplets, and liquid water.

21. The module of claim 14, wherein the porous support has a burst strength of up to about 1000 pounds per square inch.

22. A humidifier for a fuel cell, the humidifier comprising:
a first flow path for a reactant;
a second flow path for a humidifying stream; and
a membrane with gel-filled pores separating the first flow path and the second flow path.

23. The humidifier of claim 22, wherein the gel-filled pores allow transfer of water from the second flow path to the first flow path to humidify the reactant.

24. The humidifier of claim 23, and further comprising a first flow path outlet leading humidified reactant from the first flow path to the fuel cell, and a second flow path inlet leading humidified exhaust from the fuel cell to the second flow path to replenish the humidifying stream.

25. The membrane device of claim 22, wherein the gel-filled pores include larger macrovoids and smaller grainy pores.

26. The membrane device of claim 22, wherein the reactant is an oxidant stream for a cathode of the fuel cell.

27. The membrane device of claim 22, wherein the reactant is a reductant stream for an anode of the fuel cell.

28. The membrane device of claim 22, wherein the permeability of gasses through the membrane will gel-filled pores is significantly less than through a similar membrane without gel-filled pores.
